(19) United States
(12) Patent Application Publication
(10) Pub. No.: US 2009/0321207 A1
(43) Pub. Date: Dec. 31, 2009

(54) ONE-WAY CLUTCH

(76) Inventors: Atsushi Kario, Shizuoka (JP); Takeshi Itoh, Shizuoka (JP)

Correspondence Address: CERMAK KENEALY VAIDYA & NAKAJIMA LLP, 515 EAST BRADDOCK RD SUITE B, Alexandria, VA, 22314, US

(21) Appl. No.: 12/488,040

(22) Filed: Jun. 19, 2009

(30) Foreign Application Priority Data
Jun. 25, 2008 (JP) 2008-166176

(51) Int. Cl. F16D 41/06

(52) U.S. Cl. 192/45.1

(57) ABSTRACT

A one-way clutch includes a radially-outer annular member having an inner peripheral race surface, a radially-inner annular member having an outer peripheral race surface, plural torque-transmitting members interposed between the annular members such that they are selectively tiltable to first positions where they come into engagement with the race surfaces to transmit a torque and second positions where they come out of engagement with the race surfaces, a ribbon spring for biasing the torque-transmitting members in a direction that they come into engagement with the race surfaces, a cylindrical cage for holding the torque-transmitting members at predetermined angular intervals and controlling their tilting, and a pair of end bearings arranged between the annular members on axially opposite sides of the cage, respectively, and supporting the annular members in a concentric relation. The ribbon spring is arranged between the cage and the inner peripheral race surface.

### CROSS-REFERENCE TO RELATED APPLICATION

This application claims the priority of Japanese Patent Application 2008-166176 filed Jun. 25, 2008, which is incorporated herein by reference.

### TECHNICAL FIELD

The disclosed subject matter relates to a one-way clutch useful in an automatic transmission or the like for a vehicle.

### BACKGROUND ART

In a transmission or the like for an automobile, a one-way clutch is used to transmit rotation in one direction. In a torque converter, a stator is arranged between a turbine runner and a pump impeller, and the stator is mounted on a rotary shaft.

FIG. 1A is a view of essential parts of a conventional one-way clutch as seen in an axial direction with apart thereof cut away, and FIG. 1B is a cross-sectional view taken in the direction arrows IB-IB of FIG. 1A.

A one-way clutch 100 is equipped with an unillustrated inner ring, an unillustrated outer ring, sprags 102 engageable with an outer peripheral surface (not shown) of the inner ring and an inner peripheral surface (not shown) of the outer ring to transmit a torque between the inner and outer rings, an outer cage 104 and inner cage 105 for holding the sprags 102, a ribbon spring 107 for biasing the sprags 102 in an engaging direction, and end bearings 110 arranged on opposite sides of the outer cage 104 and inner cage 105.

In a one-way clutch for a torque converter, bushes are often arranged on axially opposite ends of the one-way clutch so that the bushes function as bearings for an inner and outer rings. The one-way clutch 100 equipped with the end bearings 110 can be constructed with a smaller axial dimension than those of the type that such bushes are arranged in parallel.

Upon acceleration or deceleration of the outer ring, the one-way clutch 100 rotates relative to the outer ring and inner ring due to its inertia. To resolve troubles in clutch engagement performance, a drag torque is hence applied to the outer ring. To produce such a drag torque, cutout machining is applied to the outer cage 104 to provide it with a section called an “i-bar section” 112 or “T-bar section” (not shown). The i-bar section 112 or T-bar section comes into sliding contact with an inner peripheral race surface of the outer ring to obtain a drag torque as needed (see JP-A-2004-132526).

### SUMMARY OF THE INVENTION

In the conventional one-way clutch, machining is applied to an outer cage to form an i-bar section or T-bar section so that the outer cage unavoidably needs a greater axial dimension. The conventional one-way clutches is, therefore, accompanied by a drawback that it cannot meet the outstanding demand for a reduction in axial dimension.

An object of the disclosed embodiment is, therefore, to provide a one-way clutch comprising a radially-outer annular member having an inner peripheral race surface, a radially-inner annular member having an outer peripheral race surface opposing the inner peripheral race surface in a radial direction, plural torque-transmitting members interposed between the radially-inner annular member and the radially-outer annular member such that the plural torque-transmitting members are selectively tiltable to first positions where the plural torque-transmitting members come into engagement with the inner and outer peripheral race surfaces to transmit a torque and second positions where the plural torque-transmitting members come out of engagement with the inner and outer peripheral race surfaces, a ribbon spring for biasing the plural torque-transmitting members in a direction that the plural torque-transmitting members come into engagement with the inner and outer peripheral race surfaces, a cylindrical cage for holding the plural torque-transmitting members at predetermined angular intervals and controlling tilting of the plural torque-transmitting members, and a pair of end bearings arranged between the radially-outer annular member and the radially-inner annular member on axially opposite sides of the cage, respectively, and supporting the radially-outer annular member and the radially-inner annular member in a concentric relation, wherein the ribbon spring is arranged between the cage and the inner peripheral race surface.

The cage can be arranged preferably on a side radially inner than a central position between the outer peripheral race surface and the inner peripheral race surface.

The cage can be provided preferably at an axial one end portion thereof with an inwardly-directed flange extending in a radially inner direction.

Preferably, the axial one end portion of the cage and one of the paired end bearings, said one end bearing being arranged on a same side as the one end portion, can oppose each other via a clearance in an axial direction; an axially opposite end portion of the cage and the other one of the paired end bearings, said the other end bearing being arranged on a same side as the opposite end portion, can oppose each other via a clearance in the axial direction; and, even when the paired end bearings are pressed in directions that the paired end bearings move toward each other in the axial direction, the clearances can still remain interposed such that the cage can remain free from restraint by the paired end bearings.

Preferably, the ribbon spring can be formed of a pair of side bars axially opposing each other and plural crossbars arranged at predetermined angular intervals to axially connect the paired side bars with each other, and can be provided at predetermined angular intervals with plural windows in which the torque-transmitting members are inserted, respectively, each of the windows being formed of a pair of adjacent ones of the crossbars and portions of the paired opposing side bars; and one of the paired crossbars, which form the window, can be provided with a tongue portion extending from an axial central part of the one crossbar toward the other crossbar and configured in a form of a substantially U-shape, which is convex in a radially outward direction, as viewed in cross-section, and the window-forming portions of the paired side bars can be provided with curved portions formed at positions in axial registration with the tongue portion in a form of a substantially U-shape, which is convex in the radially outward direction, as viewed in cross-section.

Preferably, the ribbon spring can be fixedly connected at opposite ends thereof and is in an annular form.

Preferably, the radially-outer annular member can be provided, as a radially outer section thereof, with a section formed with an axial width smaller than a radially inner section thereof, and on axially opposite sides of the section formed with the smaller axial width, thrust bearings can be arranged via side plates that restrict axial movements of the radially-inner annular member.

The one-way clutch according to the disclosed embodiment can be reduced in axial dimension, can be manufactured at low cost and can assure high reliability of engagement, and is suitable especially for use with a stator of a torque converter.

### BRIEF DESCRIPTION OF THE DRAWINGS

FIG. 1A is a partly-cutaway end elevational view of a conventional one-way clutch, and FIG. 1B is a cross-sectional view taken in the direction of arrows IB-IB of FIG. 1A.

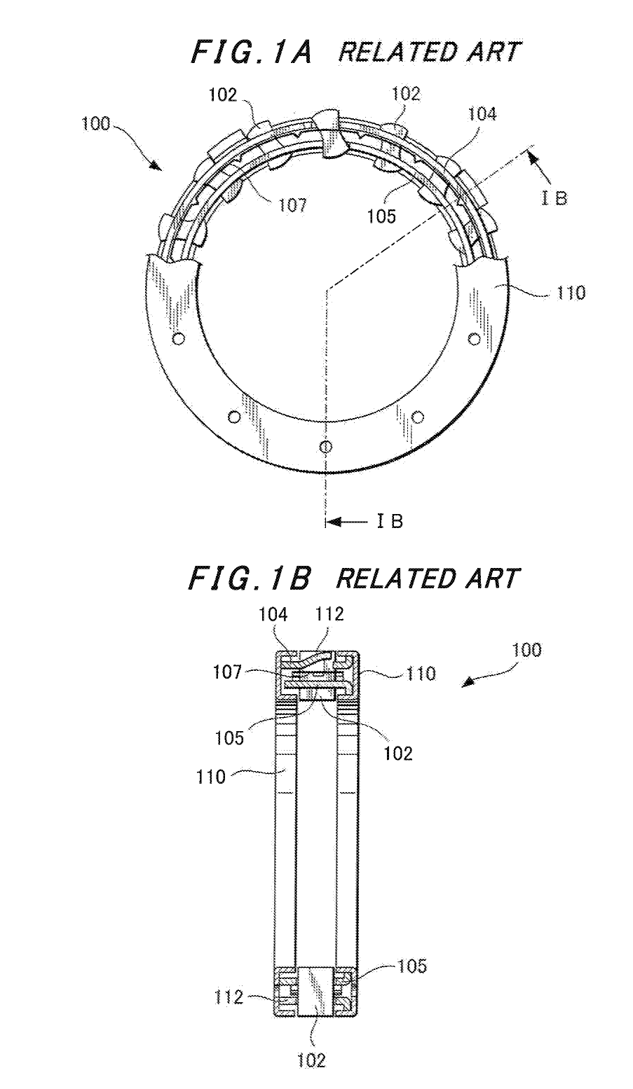

FIG. 2 is a fragmentary cross-sectional view of a one-way clutch according to the disclosed embodiment as viewed in a radial direction, in which the one-way clutch has been assembled on a stator of an unillustrated torque converter.

FIG. 3A is a partly-cutaway end elevational view of the one-way clutch according to the disclosed embodiment, and FIG. 3B is an enlarged fragmentary cross-sectional view taken in the direction of arrows IIIB-IIIB of FIG. 3A.

FIG. 4 is an enlarged fragmentary perspective view of a ribbon spring used in the one-way clutch according to the disclosed embodiment.

### DETAILED DESCRIPTION OF THE PREFERRED EMBODIMENT

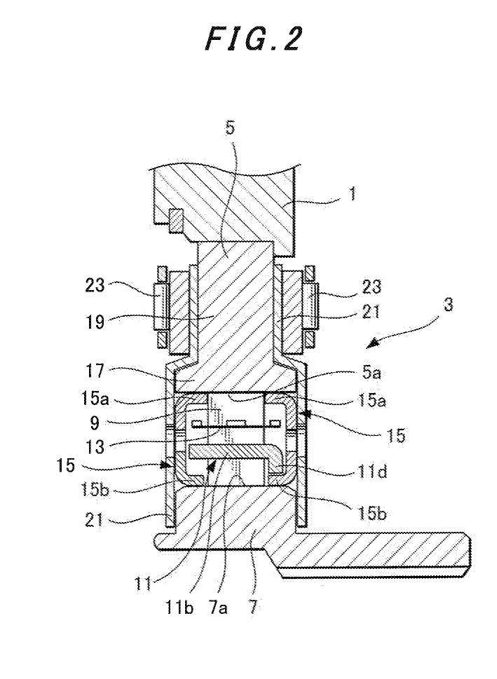

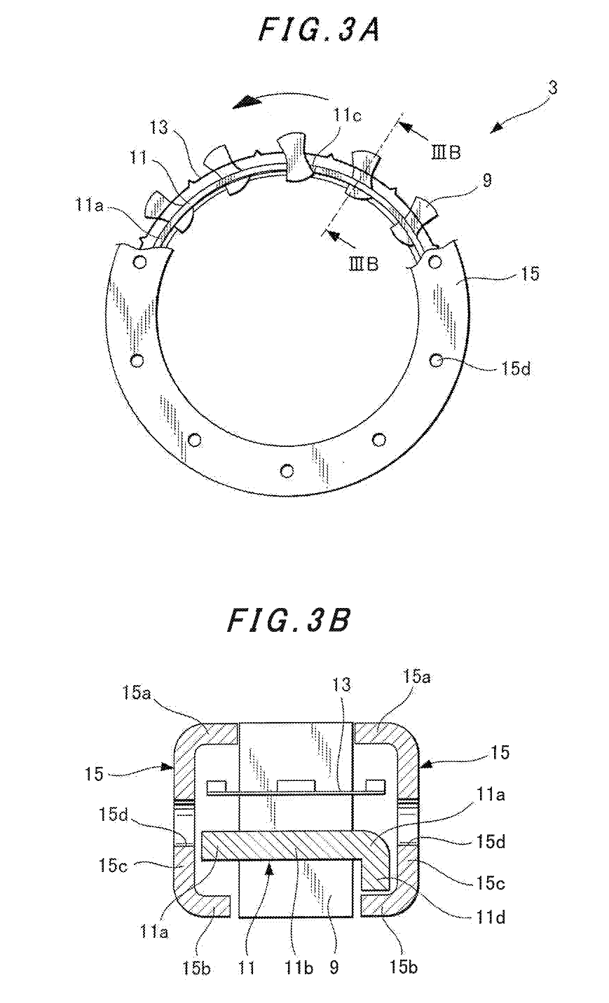

With reference to FIGS. 2 through 4 of the accompanying drawings, a one-way clutch according to the disclosed embodiment will hereinafter be described.

Between a pump impeller (not shown) and a turbine runner (not shown) of an unillustrated torque converter, a stator 1 is disposed. The stator 1 is arranged on a side of an outer periphery of an output shaft of the torque converter by way of a one-way clutch 3 to be described in detail hereinafter.

The one-way clutch 1 is provided with an outer ring 5 as a radially-inner annular member and an inner ring 7 as a radially-outer annular member. The outer ring 5 has an inner peripheral race surface 5a, while the inner ring 7 has an outer peripheral race surface 7a opposing the inner peripheral race surface 5a in a radial direction. An outer peripheral surface of the outer ring 5 comes into engagement with an inner peripheral surface of the stator 1 and rotates integrally with the stator 1, but the inner ring 7 does not rotate.

Between the inner peripheral race surface 5a of the outer ring 5 and the outer peripheral race surface 7a of the inner ring 7, plural sprags 9 are interposed. These sprags 9 are arranged such that they are selectively tiltable to first positions where they come into engagement with the inner and outer peripheral race surfaces 5a, 7a to transmit a torque and second positions where they come out of engagement with the inner and outer peripheral race surfaces 5a, 7a. The sprags 9 are held at predetermined angular intervals by a cylindrical cage 11, and their tilting is controlled by the cylindrical cage 11. Further, the sprags 9 are biased by a ribbon spring 13 a direction that they come into engagement with the inner and outer peripheral race surfaces 5a, 7a. On opposite sides of the cage 11, a pair of end bearings 15, 15a rearranged to maintain a distance between the inner and outer peripheral race surfaces 5a, 7a.

Each end bearing 15 in the one-way clutch 3 is an annular member in a form of a turned square U-shape as viewed in cross-section, and is composed of an outer, short cylindrical portion 15a, an inner, short cylindrical portion 15b, and an annular portion connecting these cylindrical portions together at one ends thereof. The annular portion 15c is provided with lubrication holes 15d at predetermined intervals. The outer diameter of the end bearing 15, in other words, the outer diameter of the outer cylindrical portion 15a is slightly smaller than the inner diameter of the inner peripheral race surface 5a of the outer ring 5. On the other hand, the inner diameter of the end bearing 15, in other words, the inner diameter of the inner cylindrical portion 15b is slightly greater than the outer diameter of the outer peripheral race surface 7a of the inner ring 7. The end bearings 15, 15 of the above-described construction are arranged in a pair on opposite sides of the sprags 9, with inner space portions of a turned square U-shape facing toward the sprags 9. By the end bearings 15, 15, the inner peripheral race surface 5a and the outer peripheral race surface 7a are maintained in a concentric relation with an adequate distance kept therebetween, and moreover, axial movements of the sprags 9 are restricted.

The outer ring 5 is composed of an inner thick section 17 and an outer thin section 19 with an axial width thereof formed smaller than the inner thick section 17. The thick section 17 has the inner peripheral race surface 5a on a radially inner side thereof. The thin section 19 extends in an axially outward direction from a central part of an outer periphery of the thick section 17, and has a width substantially equal to the axial widths of the sprags 9. On axially opposite sides of the thin section 19, thrust bearings 23 are arranged via side plates 21, 21. The outer ring 5 is supported by the thrust bearings 23 by way of the side plates 21, 21. The side plates 21 have shoulders along respective stepped portions between the thin section 19 and the thick section 17, and extend in the radial direction from the thin section 19 to the inner ring 7. Described specifically, the side plates 21, 21 extend in the radial direction along the thin section 19 and thick section 17 of the outer ring 5, the end bearings 15, 15 and axial end portions of the inner ring 7 such that the side plates 21, 21 cover axial end parts of these members. Because the side plates 21, 21 extend to the axial end portions of the inner ring 7 as described above, axial movements of the inner ring 7 are restricted by the side plates 21, 21.

In this embodiment, the single cage 11 is arranged between the inner peripheral race surface 5a and the outer peripheral race surface 7a and on a side radially inner than a central position between the inner peripheral race surface 5a and the outer peripheral race surface 7a. The cage 11 is composed of two annular parts 11a, 11a and plural transverse portions 11b. The annular parts 11a, 11a are opposing each other in the axial direction of the one-way clutch 3 in the assembled state, and the plural transverse portions 11b are arranged at predetermined angular intervals to axially connect the annular parts 11a, 11a with each other. As a whole, the cage 11 is in a cylindrical form. The cage 11 is provided with plural pockets 11 arranged at predetermined angular intervals. Each of the pockets 11c is formed of two adjacent ones of the transverse portions 11b and portions of the annular parts 11a, 11a. In these pockets 11c, the sprags 9 are tiltably fitted in a one-to-one relation.

The cage 11 is provided at an axial one end portion thereof with an inwardly-directed flange 11d extending in a radially inner direction. The inwardly-directed flange 11d comes into engagement at a radially-inner edge thereof with an outer peripheral surface of the inner cylindrical portion 15b of the adjacent end bearing 15 to achieve positioning of the cage 11. Owing to the provision of the inwardly-directed flange 11d, the position of the cage 11 is stabilized, and hence, the synchronization effect of the cage 11 is stabilized.

On the axially opposite sides of the cage 11, the end bearings 15, 15 are arranged in a pair. Sufficient clearances are maintained between the respective axial end portions of the cage 11 and the paired end bearings 15, 15. Described specifically, in the assembled state, the axial one end portion of the cage 11 and one of the paired end bearings 15, 15, said one end bearing 15 being arranged on the same side as the one end portion, are opposing each other via a clearance in the axial direction, and the axially opposite end portion of the cage 11 and the other one of the paired end bearings 15, 15, said the other end bearing 15 being arranged on the same side as the opposite end portion, are opposing each other via a clearance in the axial direction. Even when the paired end bearings 15, 15 are pressed in directions that they move toward each other in the axial direction, the clearances still remain interposed such that the cage 11 remains free from restraint by the paired end bearings 15, 15.

In other words, the cage 11 is arranged between the opposing annular portions 15c, 15c of the paired end bearings 15, 15 disposed opposite each other in the axial direction, and the axial width of the cage 11 is set such that, even when the end bearings 15, 15 are pressed from both sides in directions such that the end bearings 15, 15 move toward each other in the axial direction, the opposite end portions of the cage 11 are located with clearances from the corresponding end bearings 15, 15 without allowing the end portions of the cage 11 and the corresponding end bearings 15, 15 to contact each other. When the end bearings 15, 15 are pressed from both sides in the directions that they move toward each other in the axial direction, the inner end portions of the short cylindrical portions 15a, 15b of the respective end bearings 15, 15 come into contact with the corresponding side walls of the sprags 9. As a consequence, the opposite end portions of the cage 11 do not come into contact with the corresponding end bearings 15, 15, and the cage 11 remains free from constraint by the end bearings 15, 15. Therefore, movements of the cage 11 are not prevented, and its function to synchronize movements of the respective sprags 9 is not impaired.

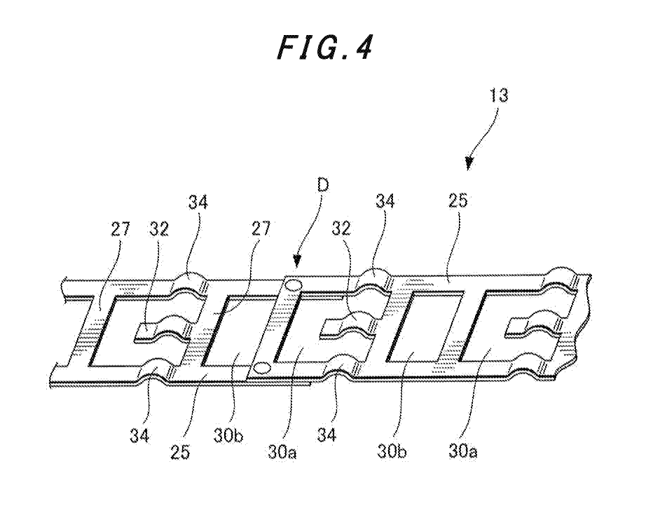

Referring next to FIG. 4, the ribbon spring 13 will be described in detail. As described above, the ribbon spring 13 is arranged between the cage 11 and the inner peripheral race surface 5a on a radially-outer side of the cage 11.

To obtain the ribbon spring 13, a member composed of a pair of side bars 25, 25 and plural crossbars 27 is used. In the assembled state, the paired side bars 25, 25 are opposing each other in the axial direction of the one-way clutch 3, and the plural crossbars 27 are arranged at predetermined intervals to connect the side bars 25, 25 with each other. The ribbon spring 13 has been constructed by forming the above-described member such that the paired side bars 25, 25 become annular. Upon forming the paired side bars 25, 25 into such annular configurations, end portions of each side bar 25 are connected and fixed together at a weld D by welding. Namely, the ribbon spring 13 is welded and fixed together at end portions thereof into an annular shape. Accordingly, the ribbon spring 13 is composed of the paired side bars 25, 25 opposing each other in the axial direction and the plural crossbars 27 arranged at the predetermined angular intervals to axially connect the paired side bars 25, 25 with each other.

The ribbon spring 13 is provided with plural windows 30 arranged at predetermined angular intervals. The windows 30 are each formed of a pair of adjacent ones of the crossbars 27 and portions of the paired opposing side bars 25, 25. These windows 30 are constructed such that windows 30a and windows 30b are alternately arrayed. The windows 30a are in registration with the pockets 11c of the cage 11 and permit the insertion of sprags 9. On the other hand, the windows 30b are shorter in angular width than the windows 30a so that no sprags 9 are inserted into the windows 30b. One of the paired crossbars 27, 27, which form each window 30a through which no sprag 9 is inserted, is provided with a tab 32 as a tongue portion, which extends from an axial central part of the one crossbar 27 toward the other crossbar 27 and biases the associated sprag 9. The tab 32 is configured in a form of a substantially U-shape, which is convex in a radially outward direction, as viewed in cross-section. The sprag 9 is inserted through the window 30a in such a manner that the tab 32 is pressed back, and in the assembled state, the sprag 9 is biased by the tab 32 in a direction that the sprag 9 comes into engagement with the inner peripheral race surface 5a and outer peripheral race surface 7a.

The portions of the paired side bars 25, 25, said portions forming the window 30a through which the sprag 9 is inserted, are provided with wrinkles 34, 34 formed as curved portions at positions in axial registration with the tab 32. The wrinkles 34, 34 are each in a form of a substantially U-shape, which is convex in the radially outward direction, as viewed in cross-section. These wrinkles 34, 34 provide the ribbon spring 13 with resiliency. Described specifically, the ribbon spring 13 is producing resilient force in the radially outward direction by the wrinkles 34, 34 in the assembled state. Under this resilient force, the sprags 9 are pressed against the inner peripheral race surface 5a of the outer ring 5. As the ribbon spring 13 is connected and fixed together at the opposite end portions thereof into the annular configuration, uniform pressing force can be applied to the respective sprags 9 in the direction toward the inner peripheral race surface 5a. As a result, a drag torque can be obtained between the sprags 9 and the inner peripheral race surface 5a.

Owing to the one-way clutch 3 of the above-mentioned construction, the stator 1 is allowed to rotate in only one direction.

The disclosed embodiment is provided with the single cage 11, and is not provided with any cage corresponding to a conventional outer cage. As mentioned above, it has heretofore been unable to reduce the axial dimension of the outer cage because of the need for the arrangement of an i-bar or T-bar section in the outer cage. With the conventional outer cage, it has been difficult to provide a one-way clutch with a reduced axial dimension. In the disclosed embodiment, on the other hand, the one-way clutch is constructed without using any outer cage. With the disclosed embodiment, the above-mentioned problem of the conventional art has been resolved, thereby making it possible to construct the one-way clutch 3 with a reduced axial dimension. Owing to the adoption of the construction that does not use any outer cage, the one-way clutch 3 exhibits reduced inertia. As a consequence, the one-way clutch 3 can follow the outer ring 5 so that the reliability of engagement can be improved. In addition, it is also possible to reduce the number of parts or components and also the manufacturing cost.

Owing to the arrangement of the ribbon spring 13 on the radially outer side of the cage 11, the one-way clutch 3 according to the disclosed embodiment can apply pressing force toward the inner peripheral race surface 5a of the outer ring 5 and also a moment in the engaging direction of the sprags 9 even in the conventional sprag configurations. As the ribbon spring 13 are fixed together at the opposite ends thereof by welding, it is also possible to make uniform the pressing force under which the respective sprags 9 are pressed against the inner peripheral race surface 5a. As a consequence, the frictional force against the inner peripheral race surface 5a can be made uniform, leading to enhanced stability of engagement.

As the wrinkles 34 of the ribbon spring 13 are configured in the form that is convex in the radially outward direction, it is possible to avoid an interference between the cage 11 and the ribbon spring 13, and hence, to avoid worn breakage of the ribbon spring 13 and an application of abnormal force to the ribbon spring 13.

In the one-way clutch 3 according to the disclosed embodiment, its axial dimension has been reduced by providing the outer ring 5 with the thin section 19 and arranging the thrust bearings 23 on the opposite sides of the thin section 19, respectively. Between the thin section 19 and the respective thrust bearings 23, the side plates 21 are arranged extending in the radial direction to the axial end portions of the inner ring 7. It is, therefore, possible to provide the one-way clutch 3 with a reduced axial dimension while retaining the rigidity of the outer ring 7.

When the one-way clutch 3 according to the disclosed embodiment is used with the stator 1 of the torque converter as described above, the inner ring 7 of the one-way clutch 3 is fixed and the outer ring 5 is in engagement with the stator 1. The cage 11 is made of a metal, and therefore, has a corresponding inertia weight. Upon reduction of a difference in rotation between an unillustrated pump impeller and an unillustrated turbine runner, the one-way clutch 3 changes from an engaged state to an idling state. In the course of this change, the inertia weight of the cage 11 acts to maintain the stationary state of the cage 11, and gives a moment to the sprags 9 such that they are tilted to bring the one-way clutch into an idling state. When a greater difference occurs in rotation between the pump impeller and the turbine runner, the one-way clutch 3 changes from an idling state to an engaged state. In the course of this change, the inertia weight of the cage 11 acts to maintain the rotation of the one-way clutch 3, and gives a moment to the sprags 9 such that they are tilted to bring the one-way clutch into an engaged state. Therefore, the change of the one-way clutch 3 from an engaged state to an idling state or from an idling state to an engaged state can be performed smoothly.

As has been described above, the disclosed embodiment can provide a one-way clutch which can be reduced in axial dimension, can be manufactured at low cost and can assure high reliability of engagement.

It is to be noted that the present invention is not limited to the above-described embodiment and can be modified in various ways.

1. A one-way clutch comprising:
a radially-outer annular member having an inner peripheral race surface,
a radially-inner annular member having an outer peripheral race surface opposing said inner peripheral race surface in a radial direction,
plural torque-transmitting members interposed between said radially-inner annular member and said radially-outer annular member such that said plural torque-transmitting members are selectively tiltable to first positions where said plural torque-transmitting members come into engagement with said inner and outer peripheral race surfaces to transmit a torque and second positions where said plural torque-transmitting members come out of engagement with said inner and outer peripheral race surfaces,
a ribbon spring for biasing said plural torque-transmitting members in a direction that said plural torque-transmitting members come into engagement with said inner and outer peripheral race surfaces,
a cylindrical cage for holding said plural torque-transmitting members at predetermined angular intervals and controlling tilting of said plural torque-transmitting members, and
a pair of end bearings arranged between said radially-outer annular member and said radially-inner annular member on axially opposite sides of said cage, respectively, and supporting said radially-outer annular member and said radially-inner annular member in a concentric relation,
wherein said ribbon spring is arranged between said cage and said inner peripheral race surface.

2. The one-way clutch according to claim 1, wherein said cage is arranged on a side radially inner than a central position between said outer peripheral race surface and said inner peripheral race surface.

3. The one-way clutch according to claim 2, wherein said cage is provided at an axial one end portion thereof with an inwardly-directed flange extending in a radially inner direction.

4. The one-way clutch according to claim 3, wherein said axial one end portion of said cage and one of said paired end bearings, said one end bearing being arranged on a same side as said one end portion, oppose each other via a clearance in an axial direction; an axially opposite end portion of said cage and the other one of said paired end bearings, said the other end bearing being arranged on a same side as said the opposite end portion, oppose each other via a clearance in the axial direction; and, even when said paired end bearings are pressed in directions that said paired end bearings move toward each other in the axial direction, said clearances still remain interposed such that said cage remains free from restraint by said paired end bearings.

5. The one-way clutch according to claim 1, wherein said ribbon spring is formed of a pair of side bars axially opposing each other and plural crossbars arranged at predetermined angular intervals to axially connect said paired side bars with each other, and is provided at predetermined angular intervals with plural windows in which said torque-transmitting members are inserted, respectively, each of said windows being formed of a pair of adjacent ones of said crossbars and portions of said paired opposing side bars; and
one of said paired crossbars, which form said window, is provided with a tongue portion extending from an axial central part of said one crossbar toward the other crossbar and configured in a form of a substantially U-shape, which is convex in a radially outward direction, as viewed in cross-section, and said window-forming portions of said paired side bars are provided with curved portions formed at positions in axial registration with said tongue portion in a form of a substantially U-shape, which is convex in the radially outward direction, as viewed in cross-section.

6. The one-way clutch according to claim 5, wherein said ribbon spring is fixedly connected at opposite ends thereof and is in an annular form.

7. The one-way clutch according to claim 1, wherein said radially-outer annular member is provided, as a radially outer section thereof, with a section formed with an axial width smaller than a radially inner section thereof, and on axially opposite sides of said section formed with the smaller axial width, thrust bearings are arranged via side plates that restrict axial movements of said radially-inner annular member.
